(19) United States
(12) Patent Application Publication
(10) Pub. No.: US 2010/0165902 A1
(43) Pub. Date: Jul. 1, 2010

(54) USAGE OF POLICY INFORMATION FOR NETWORK SUPPORTED SELECTION OF UNICAST VERSUS MBMS

(76) Inventors: Tor Kvernvik, Taby (SE); Tang Wenhu, Shanghai (CN); Jialu Zhang, Shanghai (CN)

Correspondence Address: ERICSSON INC., 6300 LEGACY DRIVE, M/S EVR 1-C-11, PLANO, TX, 75024, US

(21) Appl. No.: 12/097,718

(22) PCT Filed: May 3, 2006
(86) PCT No.: PCT/SE2006/050094

§ 371 Date: Aug. 9, 2008

(30) Foreign Application Priority Data
Dec. 14, 2005 (SE) 0502778-4

(51) Int. Cl. H04H 20/71

(52) U.S. Cl. 370/312

(57) ABSTRACT

The present invention relates to an arrangement and method for a mobile telecommunication network comprising a policy node (PCRF) connected to a gateway (GGSN) and a streaming server, respectively, for selecting to distribute a content with unicast or broadcast/multicast from the streaming server to users via the core network and the radio network, wherein the arrangement comprises means for initiating a streaming content distribution by a unicast distribution. The arrangement comprises means for retrieving content information from the streaming server, means for retrieving geographical information to determine a geographical position for said users, means for processing the retrieved content information and the retrieved geographical information to determine the number of users consuming the content within a predefined geographical area, and means for selecting to distribute the content by unicast or broadcast/multicast based on the determined number of users consuming the content within a predefined geographical area.

### TECHNICAL FIELD

The invention generally relates to the field of streaming content distribution services such as television (TV) services. In particular, the invention relates to a content distribution technique that adaptively employ a suitable transport bearer type.

### BACKGROUND

Today, mobile TV services and other streaming content distribution services are delivered over existing networks using so-called unicast delivery. Unicast delivery means that each user terminal gets its own unique data connection for accessing one or more content channels. One drawback of this approach is that it does not scale satisfactorily if an increasing number of user terminals is starting to use a particular service.

An alternative to unicast delivery is broadcast delivery. In a broadcast scenario each channel carrying the content is distributed to all user terminals simultaneously. In this way, the number of data connections can be significantly reduced because the number of required data connections only depends on the number of distributed channels and no longer on the number of active user terminals.

Although broadcasting reduces the number of required data connections, it is important to understand that broadcasting is not always the most efficient way of delivering content channels. In a typical broadcast scenario, content channels are transmitted even if there are no user terminals listening to them since the broadcasting system does not have any knowledge about who is listening to a channel and who is not. Furthermore, the transmission power of a broadcast bearer in a radio cell cannot be adapted to the receive conditions of different user terminals. Instead it must be sufficiently high such that even user terminals with bad coverage can still receive a signal that is good enough.

Compared to broadcast, unicast delivery has the advantage that network resources are only allocated if requested. Furthermore, with unicast delivery a base station can optimize its transmission power for each user terminal individually such that user terminals closer to the base station require less power than user terminals further away.

In addition to broadcast and unicast, multicast is a third transport alternative. Multicast adds group management capabilities to broadcast. However, support for multicast requires an increased implementation effort compared to broadcast. Multicast support can for example be provided via the Multimedia Broadcast Multicast Service (MBMS) that was introduced in 3GPP R6 (3^{rd} generation partnership project, Release 6).

Today streaming content is mainly distributed via unicast channels. However, broadcast and multicast is more efficient for content distribution when many users view the same content simultaneously within the same area e.g. in the same cell. In most other cases it is more efficient to use unicast.

### SUMMARY

The object of the present invention is to achieve a method and arrangement for adaptively determining when it is more advantageous to change from unicast distribution to broadcast/multicast distribution.

The object is achieved by the method and arrangement defined by the independent claims. Embodiments of the invention are defined by the dependent claims.

The method according to the present invention comprising the steps of retrieving content information from the streaming server, retrieving geographical information to determine a geographical position for the users, processing the retrieved content information and the retrieved geographical information to determine the number of users consuming the content within a predefined geographical area, and selecting to distribute the content by unicast or broadcast/multicast based on the determined number of users consuming the content within a predefined geographical area makes it possible to adaptively determine when it is more advantageous to change from unicast distribution to broadcast/multicast distribution.

The arrangement according to the present invention is adapted for connection to a mobile telecommunication network comprising a policy node (PCRF) connected to a gateway (GGSN) and a streaming server, respectively, for selecting to distribute a content with unicast or broadcast/multicast from the streaming server to users via the core network and the radio network, wherein the arrangement comprises means for initiating a streaming content distribution by a unicast distribution. The arrangement comprising means for retrieving content information from the streaming server, means for retrieving geographical information to determine a geographical position for said users, means for processing the retrieved content information and the retrieved geographical information to determine the number of users consuming the content within a predefined geographical area, and means for selecting to distribute the content by unicast or broadcast/multicast based on the determined number of users consuming the content within a predefined geographical area makes it possible to adaptively determine when it is more advantageous to change from unicast distribution to broadcast/multicast distribution.

According to one embodiment, the broadcast/multicast distribution is selected if the determined number of users consuming the content within a predefined geographical area is above a predefined threshold.

According to a further embodiment, the processing is performed by a policy node (PCRF) and the result of the processing step is transferred to a cast selector of a distribution controller, wherein the distribution controller is interconnected between the policy node and the streaming server.

According to a further embodiment, the processing step is performed by a cast selector of a distribution controller, wherein the distribution controller is interconnected between the policy node and the streaming server and content information is retrieved from the streaming server via the policy node and the geographical information is retrieved from the policy node.

According to a further embodiment, the cast selector comprises selecting means adapted to perform the selection.

According to embodiments of the present invention the geographical information is retrieved from the gateway via the Gx interface to the policy node and/or from the Mobile Positioning Center.

An advantage with the present invention is that it is possible to avoid wasting multicast and broadcast bearers when there is only a few users consuming the content distributed by the multicast and broadcast bearers.

### BRIEF DESCRIPTION OF THE DRAWINGS

In the following, the invention will be described with reference to exemplary embodiments illustrated in the drawings, wherein:

FIG. 1 depicts a 3G mobile telecommunication network according to prior art wherein the present invention can be implemented.

FIG. 2 depicts a distribution controller according to the present invention connected to the mobile telecommunication network of FIG. 1.

FIG. 3 depicts a distribution controller according to the present invention.

FIG. 4 depicts how the functionalities of the content delivery node are connected to the mobile telecommunication network of FIG. 1 according to one embodiment of the invention

FIG. 5 is a flowchart of the method according to the present invention.

FIG. 6 illustrates schematically the arrangement of the present invention.

### DETAILED DESCRIPTION

In the following description, for purposes of explanation and not limitation, specific details are set forth, such as particular sequences of steps, signalling protocols and device configurations in order to provide a thorough understanding of the present invention. It will be apparent to one skilled in the art that the present invention may be practised in other embodiments that depart from these specific details. Moreover, those skilled in the art will appreciate that the functions explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

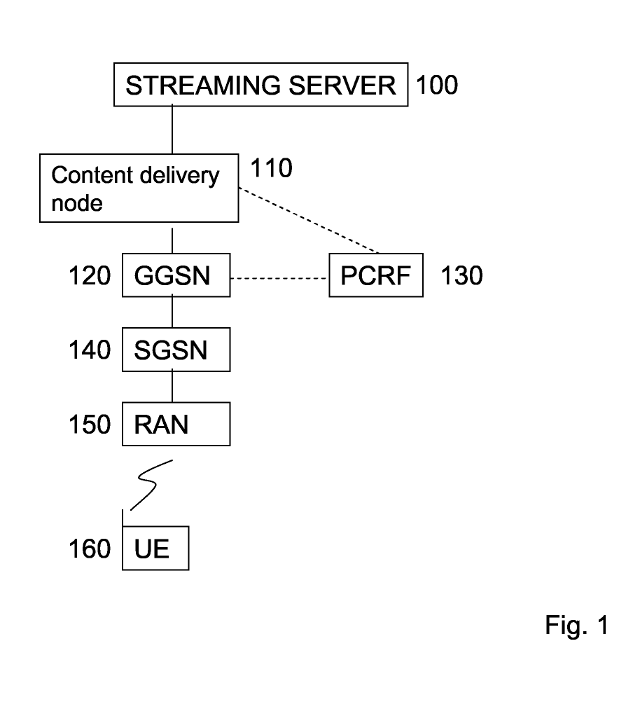

The present invention is adapted to be implemented in a mobile telecommunication network. An example of such a telecommunication network is illustrated in FIG. 1, wherein a 3G mobile telecommunication network is shown. The User Equipments (UEs) 160 also referred to as users are wirelessly connectable to the Radio Access network (RAN) 150. The RAN 150 comprises radio base stations controlled by a Radio Network Controller. The RAN 150 is connected to the CN via the serving GPRS support node (SGSN) 140 and the SGSN 140 is further connected to the gateway GPRS support node (GGSN) 120. The SGSN 140 provides packet routing and transfer to and from the SGSN service area, session management, mobility management, the logical link management towards the UE etc. The GGSN 120 provides e.g. the interface towards external networks and session management. The GGSN 120 is further connected to a policy node 130 which is further described below and to a content delivery node 110 handling unicast distribution. The content delivery node is further connected to the streaming server 100. The content delivery node comprises a proxy associated with the streaming server which implies that the PCRF can receive streaming server related information from the content delivery node.

As stated above, the object of the present invention is to achieve a method and arrangements for adaptively determining when a content distributed by unicast instead should be distributed by means of broadcast/multicast. (Broadcast/multicast implies in this application that either broadcast or multicast can be used.) The decision whether unicast or broadcast/multicast is the preferred bearer type is according the present invention based on information of the number of users that are receiving the same content distribution within a limited area. If the number of users receiving the same content are above a pre-defined threshold, broadcast/multicast is used, otherwise unicast should be used. The entity that makes the decision must hence be aware of geographical information associated to users and also information related to users' ongoing sessions such as the service and the session content.

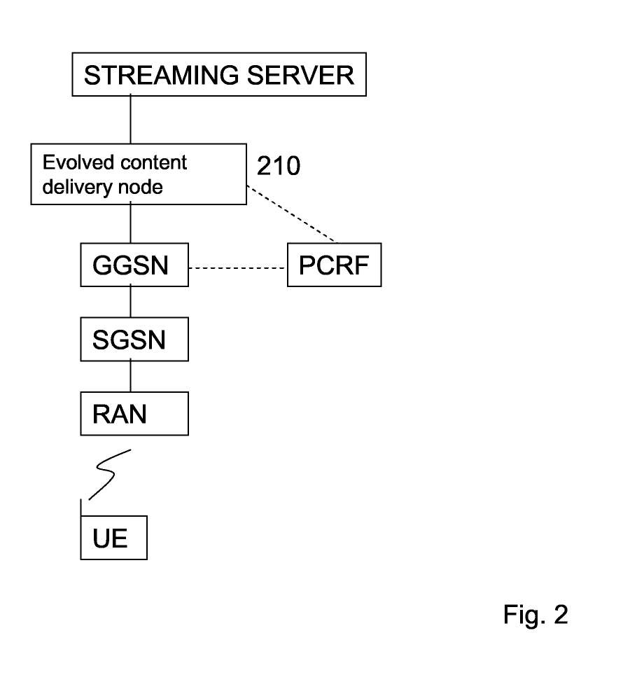

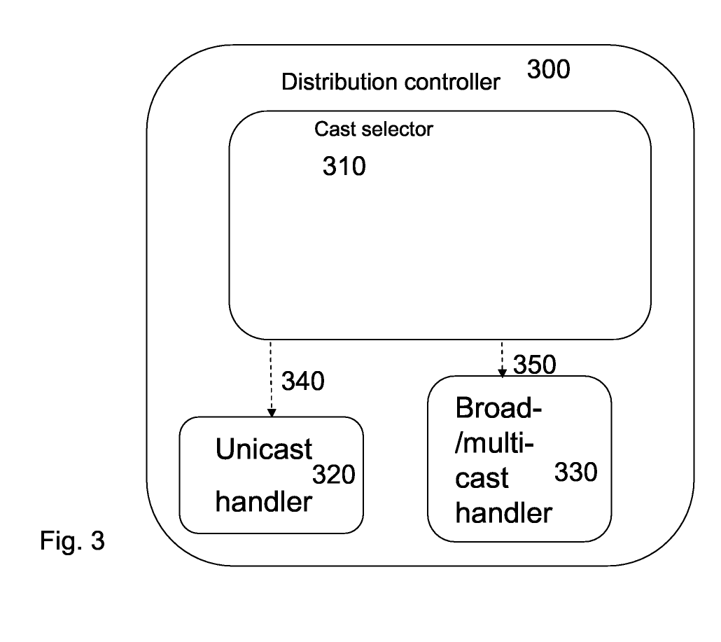

The content data from the application server, i.e. in this case the streaming server, is forwarded to the gateway, the GGSN and then to the users via the radio network. Thus, an evolved content delivery node 210 further comprising an entity denoted distribution controller is introduced by the present invention, configured to select whether to distribute the content by means of unicast or broadcast/multicast to the users as illustrated in FIG. 2. The evolved content delivery node 210 comprises the proxy associated with the streaming server as the prior art content delivery node. A detailed description of the distribution controller is provided below in conjunction with FIG. 3. Said distribution controller requires information of the content the users receive and the geographical area of the users such that the users consuming the same content within a pre-defined area can be determined.

The streaming server and the distribution controller has knowledge about the service and the content, e.g. a description of the content such as a Service Identifier (SI) that is being sent and how the content is mapped on the media channel such as source address and port number. The streaming server has however no knowledge of the location of the users receiving the distributed content. Detailed knowledge about the users can instead be obtained from the radio network whereas the radio network has limited knowledge about the content that is being sent over the radio network. The core network is aware of the status of the PDP context of the media channel, the geographical location in a higher level, such as the SGSN serving area and roaming status. The core network has however no knowledge of the individual flows that are being carried within a single PDP context.

In 3GPP R7 the Policy and Charging Control (PCC) concept is introduced. This enables the core network to view and control individual flows within a PDP context. The central point for policy control is in a policy node denoted the Policy and charging rule function (PCRF) as illustrated in FIG. 1. That implies that the PCC function makes it possible to take decisions and to perform control based on the information available in the policy node about the IP session. The PCC function is involved in the setup, modification and disconnection of the bearers related to the service and may influence and also initiate this based on the available information. The policy node also has knowledge and is involved in the mapping of the services on the respective bearers. Thus, the policy node also referred to as the PCRF is configured to collect information about all users and their sessions. From the streaming server the policy node is configured to collect session information that can be used to identify the content to be downloaded to the terminal/equipment for a specific user and a specific session.

As illustrated in FIG. 1, the policy node PCRF is via the Gx interface connected to the GGSN and to the content delivery node via the Rx interface. The content delivery node is further connected to the streaming server. The streaming server is a type of application server providing the content to be streamed. The policy node PCRF receives information from the streaming server via the content delivery node. The content delivery node comprises a unicast handler and a content delivery proxy. The content delivery proxy is configured to manage session management, traffic control and QoS monitoring. Additionally, the content delivery proxy creates charging data and provides an interface to the support nodes that perform Billing, Authentication, as well as user Subscriber Management. It also serves as a, RTSP-, Proxy.

The basic idea of the present invention is to retrieve geographical information such that users within a specified area can be identified, retrieve content information for a first content from the policy node such that the first content consumed by the users can be identified and to process the retrieved geographical information with the content information in order to determine the number of users within a predefined area consuming the first content. The decision whether to change from unicast to broadcast/multicast distribution or to keep using unicast distribution is then made based on said determined number of users such that broadcast/multicast is selected if said number of users is above a predefined threshold.

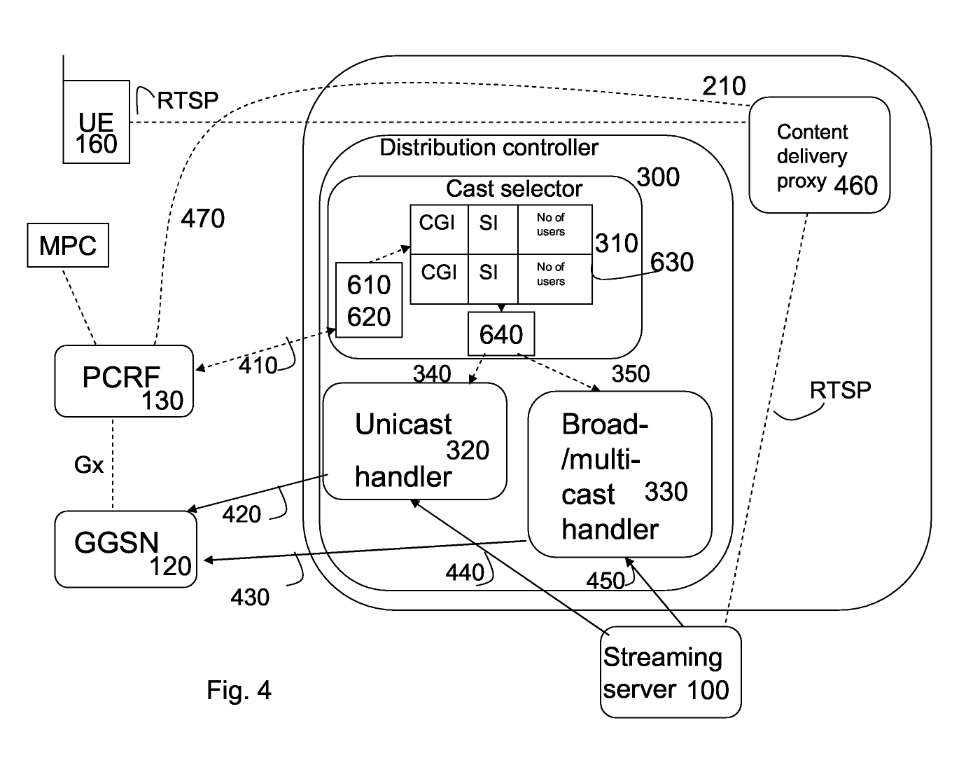

In accordance with the present invention, the content delivery node is evolved by the introduction of a distribution controller. As illustrated in FIGS. 3 and 4, the distribution controller 300 comprises a cast selector 310 and a unicast handler 320, and broadcast/multicast handler 330 connected to the cast selector 310 via 340 and 350, respectively. The unicast handler 320 is configured to setup and control the unicast sessions and the broadcast/multicast handler 330 is configured to setup and control the broadcast/multicast sessions. The cast selector 310 is configured to, when the number of users in a certain area that consumes the same content reaches a certain threshold and there is at least one free broadcast/multicast bearer, initiate the distribution of the identified content on one of the preconfigured broadcast/multicast bearers.

The table with the information of the number of users consuming the same service per geographic area can be maintained either in a policy node such as the PCRF or in the cast selector of the distribution controller. If the table is maintained in the distribution controller, the policy node needs to update the distribution controller when new sessions are initiated or existing sessions deleted. If the table is maintained in the policy node, the policy node shall inform the distribution controller when the number of users/content/area reaches certain thresholds

According to the present invention the geographical information is retrieved to the policy node that already comprises the content information. Examples of content information are service identifier (SI) and port number. According to one embodiment the geographical information and the content information are combined in the policy node and the result of the combination, i.e. the number of users consuming the same content within a predetermined area, is transmitted to the cast selector of the distribution controller that determines whether to distribute the first content by means of broadcast/multicast or unicast. In that case the cast selector may be adapted to request the number of users consuming the same content within a predetermined area from the policy node. The request may be performed on demand, periodically, at initiation of a service or one or more specified geographical areas or contents can be asked for. According to another embodiment the geographical information is retrieved to the cast selector of the distribution controller via the policy node and the content information for the content is transmitted to the cast selector of the distribution controller from the policy node, wherein the cast selector is configured to perform the combination of the geographical information and the content information.

Thus, the present invention provides means for transferring geographical information associated with a user to the policy node. This geographical information can either be retrieved from the gateway (GGSN) via the Gx interface or from the Mobile Positioning Center (MPC). The geographical information retrieved from the gateway (GGSN) is preferably the Cell Global Identifier (CGI) or Service Area Identifier (SAI) whereas the geographical information retrieved from the MPC may also be CGI and SAI in addition to more precise information such as geographical coordinates. According to a further alternative, correctness of the geographical information from the gateway received via the Gx interface can be improved by retrieving further geographical information from the MPC. I.e. both geographical information from the gateway and from the MPC may be transferred to the policy node.

Therefore, according to one embodiment, the policy node is configured to receive geographical information from the gateway (GGSN). The Gx interface is hence according to the present invention adapted to transfer geographical information from the gateway to the policy node. According to another embodiment the policy node is configured to receive geographical information from the Mobile Positioning Center (MPC). An interface between the policy node and the MPC is hence provided as illustrated in FIG. 4. The geographical information from the MPC may either be the only geographical information provided to the policy node or a complement to geographical information received over the Gx interface as stated above. In case the positioning information received from the gateway (GGSN) over the Gx interface is not sufficient there may be a need to request additional positioning information from MPC. A time stamp on the CGI received via Gx could e.g. show if the user position needs to be updated This could for example be used if the users has been consuming the same content for a long time and hence may have changed geographical area. It could also be the case if there is no bearer modification or initiation in combination with the start of the download. The Gx and the Rx interface will therefore be affected by the present invention. The Gx interface is specified by TS 29.210 Charging rule provisioning over Gx interface and the Rx interface is specified by TS 20.211 Rx Interface and Rx/Gx signalling flows.

The policy node is according to one embodiment configured to process the collected session information that has been collected for different sessions and to sort the information for the purpose of continuously calculate how many users that are downloading the same content during the same time period in a predefined area, e.g. a specific cell. The policy node is further configured to receive a request from the cast selector of the distribution controller to notify the cast selector of the distribution controller when the number of users consuming a specific content within a predefined area and configured for performing said notification. The cast selector is according to this embodiment configured to request the policy node to performing said notification and to receive information associated with the number of users consuming the same content in a predefined area on the interface denoted 410.

The policy node is according to another embodiment configured to transmit the collected content information and the collected geographical information to the distribution controller by means of the interface 410. The transmission may be performed on demand, periodically or for each new or updated session. In order to limit signalling between the policy node and the distribution controller the retrieved information could be configured in the policy node for which geographical areas and for which services it is interesting to receive updates. The cast selector is according to this embodiment configured to process the received information for the purpose of continuously calculate how many users that are downloading the same content during the same time period in a predefined area, e.g. a specific cell. The collected information and the result of the processing is preferably stored in a table.

The cast selector is according to the present invention configured to request the broadcast/multicast selector to distribute the content if said number of users is above a predefined threshold, otherwise the unicast selector will keep distributing the content by unicast distribution.

As stated above, the present invention introduces an interface between the policy node and the cast selector of the distribution controller as illustrated in FIG. 4 denoted by 410. This interface is according to one embodiment of the present invention used for carrying information required to estimate the decision when to change from unicast to broadcast/multicast from the policy node to the cast selector of the distribution controller. Moreover, the interface is used for carrying a request for obtaining said information. According to the alternative embodiment the interface between the policy node and the cast selector is configured to carry information associated with the number of users consuming the same content within a predefined area and request for obtaining said information.

Turning now to FIG. 4 showing an example of the nodes and functionality involved when selecting distribution by unicast versus broadcast/multicast by suitable bearers when the functionality for determining the number of users consuming the same content is located in the cast selector. The continuous lines illustrate data flows while the dotted lines illustrates control information flows. The streaming server 100 initiates the unicast stream. It should however be noted that in this case, the content is fed to both the unicast handler 320 and the broadcast/multicast handler 330 via the interfaces 440 and 450 but the content is only forwarded by the unicast handler via 420. The cast selector 310 is configured to control which of the unicast handler 320 and the broadcast/multicast handler 330 that should forward the content to the GGSN by the selecting means 640. The content is irrespective of unicast or broadcast/multicast distributed to the users 160 via the GGSN 120 and SGSN and the RAN.

During setup of a unicast stream the policy node is involved and gets knowledge about the new streams via the interface 470 from the content delivery proxy 460. The policy node also has knowledge about all existing streams (sessions) that are currently ongoing. The Service Information sent via this interface 470 contains information that can be used to identify the individual stream i.e. application identifier, IP source address, port. (Some streaming servers may use the source port to identify the individual stream).

When the streaming session is activated in the UE, the QoS for the bearer will be updated i.e. activation of a new secondary PDP context or a modification of an existing bearer. An existing IP session is activated in the policy node. The IP session comprises information received via the Gx and the interface denoted 470. From the GGSN via the Gx interface is bearer information provided e.g. status of PDP context, radio access type. According to one embodiment geographical information such as SGSN address, roaming status, CGI is provided from the GGSN over the Gx interface. That implies that the geographical information CGI or SAI is added to the Gx protocol. According to an alternative embodiment, the geographical information is obtained from the MPC as described above or from both the GGSN and the MPC.

Therefore, the policy node will have all the input required to estimate the decision when to change from unicast to broadcast/multicast. As stated above, said input may be used in the policy node for determining the number of users consuming the same content within a predefined area or transmitted to the cast selector that determines the number of users consuming the same content within a predefined area.

A scenario wherein the present invention is used is described below. There are a number of ongoing unicast streams from the streaming server. The cast selector 310 of the distribution controller 300 retrieves information of the content of the streams and the geographical information by the retrieving means 610 and 620 and comprises processing means 630 adapted to process said information maintained in a table in order to determine the number of users consuming the same content within a predetermined area. The content information (e.g. service identity) is received from the streaming server via the policy node and geographical information (such as SAI and CGI) is received from the PCRF via Gx and/or from the MPC. The pre-conditions for the scenario is that 2-3 MBMS broadcast bearers are configured per service area and the distribution controller schedules channels on available broadcast bearers. When the number of users consuming the same content in the same area by unicast distribution exceeds a certain threshold, otherwise use unicast (PSS).

When a new UE attaches to the network (Primary PDP context activation) there will be a new IP session initiated via Gx in the policy node. The UE IP address and the current geographical position will be transferred to the policy node.

When the user starts to view a TV channel (e.g. TV4) there will be a setup phase signalled between the UE client and the streaming server via the content delivery proxy 460 by means of the Real Time Streaming Protocol (RTSP). RTSP is further described on ftp://ftp.rfc-editor.org/in-notes/rfc2326.txt. The RTSP signaling will pass the content delivery proxy. The content delivery proxy 460 will parse the RTSP signaling e.g. by means of Session description Protocol (SDP) further described in RFC 2327 in order to detect the required QoS, IP flow and policies for the bearer level.

The content delivery proxy 460 will push the requested policy information to the policy node via the interface 470. Examples of the message containing policy information are

AAR(UE IP addr.+ ports, sess. Id. MCs, event notification subscr)
Media-Component-Description:
{ Media-Component-Number }
*[ Media-Sub-Component ]
[ AF-Application-Identifier ]=Service Identifier
[ Media-Type ]
[ Max-Requested-Bandwidth-UL ]
[ Max-Requested-Bandwidth-DL ]
[ Flow-Status ]
[ RS-Bandwidth ]

The important elements of the invention are written in bold text and it should also be noted that the Rx standard is still evolving and the names may still be changed.

Thus, the push message will include information to identify the flow and the QoS. The push message will also include a Service Identifier (denoted application identifier above) that can be used to identify the content. A new dynamic policy rule will be created in the IP session.

The policy node will add this information to the already established IP session.

The policy node will either wait for a pull request received from GGSN when the new or modified bearer is setup or initiate a push message towards the GGSN in order to SETUP a new bearer or modify an existing bearer. This will issue a response to the policy node with information from the GGSN. In this information there will be included geographical information i.e. CGI/SAI/SGSN.

The information above will be included in the new dynamic policy rule in the IP session in policy node and the information will also be reported to the cast selector via the new interface.

The cast selector will in this example keep and update a table based on the information received above i.e. number of users consuming the same content in the same location e.g. by inspecting a Service Indicator identifying the service.

When said number of users is passing a preconfigured threshold the cast selector will order the broadcast/multicast handler 330 via the interface 350 to start sending the identified content to the service area identified above and via the preconfigured broadcast bearers already established and order the unicast handler 320 via the interface 340 to stop sending the identified content to the service area identified above.

The client in the concerned UEs is according to the present invention configured to continuously monitor on the broadcast/multicast channels and hence order disconnection of the unicast bearer and start consuming the content via broadcast/multicast when the content is available on the broadcast bearer.

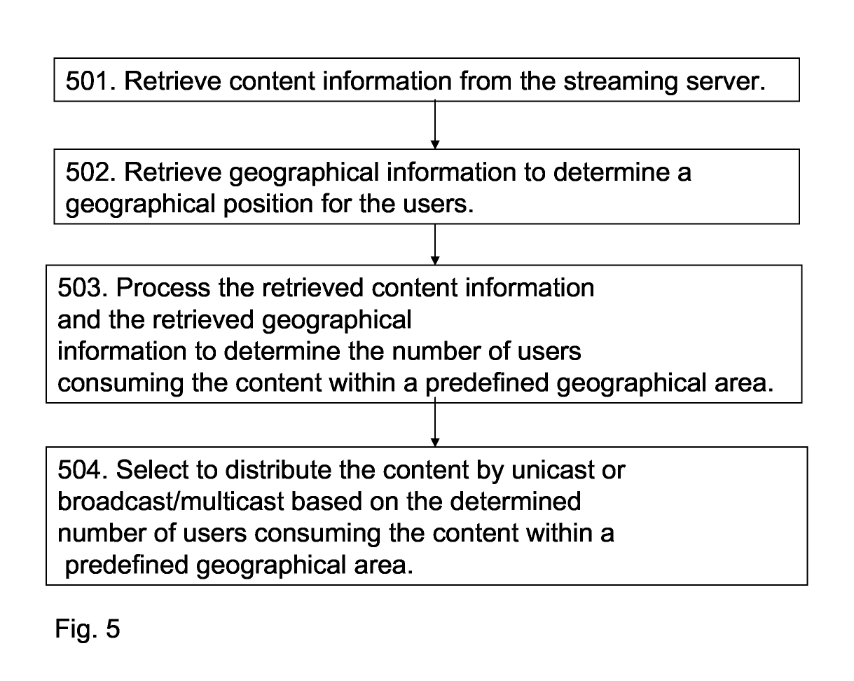

The present invention relates to a method in a mobile telecommunication network comprising a policy node connected to a gateway and a streaming server for selecting to distribute a content with unicast or broadcast/multicast from the streaming server to a user via the core network and the radio network, wherein a streaming content distribution is initiated by a unicast distribution. The method according to the present invention is illustrated by the flowchart of FIG. 5 and comprises the steps of:
501. Retrieve content information from the streaming server.
502. Retrieve geographical information to determine a geographical position for the users.
503. Process the retrieved content information and the retrieved geographical information to determine the number of users consuming the content within a predefined geographical area.
504. Select to distribute the content by unicast or broadcast/multicast based on the determined number of users consuming the content within a predefined geographical area.

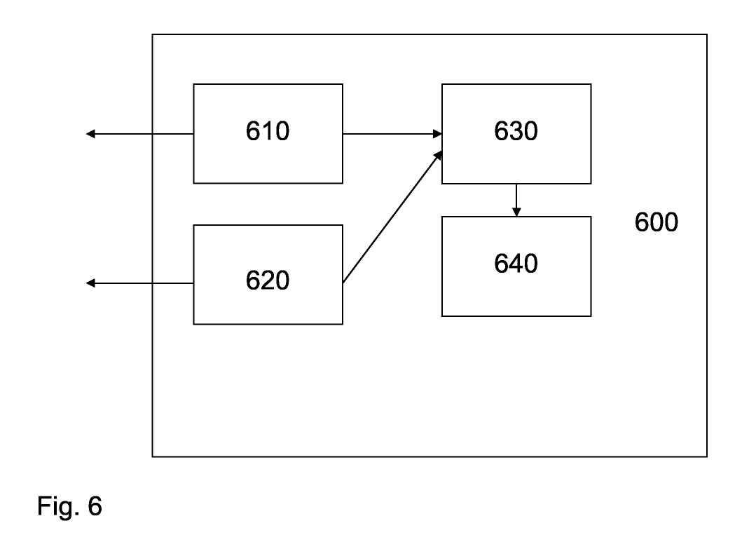

Further, the present invention relates to an arrangement, wherein the arrangement according to one embodiment is located in a policy node such as the PCRF or according to another embodiment located in the distribution controller. The arrangement is schematically illustrated in FIG. 6 and comprises retrieving means 610 adapted to retrieve content information from the streaming server, retrieving means 620 adapted to retrieve geographical information to determine a geographical position for users, processing means 630 adapted to process the retrieved content information and the retrieved geographical information to determine the number of users consuming the content within a predefined geographical area, and selecting means 640 adapted to select to distribute the content by unicast or broadcast/multicast based on the determined number of users consuming the content within a predefined geographical area.

It should be noted that the 3G-standard is still evolving and the names of the nodes such as the GGSN and SGSN may change. Thus, e.g. the term gateway and GGSN is in this application used to describe any gateway of a mobile telecommunication network having at least the functionality of the described gateway (GGSN).

While the present invention has been described with respect to particular embodiments (including certain device arrangements and certain orders of steps within various methods), those skilled in the art will recognize that the present invention is not limited to the specific embodiments described and illustrated herein. Therefore, it is to be understood that this disclosure is only illustrative. Accordingly, it is intended that the invention be limited only by the scope of the claims appended hereto.

1. A method in a mobile telecommunication network comprising a policy node connected to a gateway and a streaming server for selecting to distribute a content with unicast or broadcast/multicast from the streaming server to users via the core network and the radio network, wherein a streaming content distribution is initiated by a unicast distribution, the method comprises the steps of:
retrieving content information from the streaming server,
retrieving geographical information to determine a geographical position for said users,
processing the retrieved content information and the retrieved geographical information to determine the number of users consuming the content within a predefined geographical area, and
selecting to distribute the content by unicast or broadcast/multicast based on the determined number of users consuming the content within a predefined geographical area.

2. The method according to claim 1, wherein that broadcast/multicast distribution is selected if the determined number of users consuming the content within a predefined geographical area is above a predefined threshold.

3. The method according to claim 1, wherein the processing step is performed by a policy node and the result of the processing step is transferred to a cast selector of a distribution controller.

4. The method according to claim 1, wherein the processing step is performed by a cast selector of a distribution controller, and content information is retrieved from the streaming server via the policy node and the geographical information is retrieved from, the policy node.

5. The method according to claim 1, wherein the selecting step is performed by the cast selector.

6. The method according to claim 1, wherein the geographical information is retrieved from the gateway via the Gx interface to the policy node.

7. The method according to claim 6, wherein the geographical information is an identity of at least one cell.

8. The method according to claim 6, wherein the geographical information is the Cell Global Identity or the Service Area Identity.

9. The method according to claim 1, wherein the geographical information is retrieved from the Mobile Positioning Center, MPC to the policy node.

10. The method according to claim 9, wherein the geographical information is an identity of at least one cell or geographical coordinates.

11. An arrangement for a mobile telecommunication network comprising a policy node connected to a gateway and a streaming server, respectively, for selecting to distribute a content with unicast or broadcast/multicast from the streaming server to users via the core network and the radio network, wherein the arrangement comprises means for initiating a streaming content distribution by a unicast distribution, the arrangement further comprising retrieving means adapted to retrieve content information from the streaming server, retrieving means adapted to retrieve geographical information to determine a geographical position for said users, processing means adapted to process the retrieved content information and the retrieved geographical information to determine the number of users consuming the content within a predefined geographical area, and selecting means adapted to select to distribute the content by unicast or broadcast/multicast based on the determined number of users consuming the content within a predefined geographical area.

12. The arrangement according to claim 11, wherein the selecting means adapted to distribute the content by unicast or broadcast/multicast based on the determined number of users consuming the content within a predefined geographical area comprises means for distributing the content by broadcast/multicast if the determined number of users consuming the content within a predefined geographical area is above a predefined threshold.

13. The arrangement according to claim 11, wherein the processing means is in the policy node and the policy node comprises further means for transferring the result of the processing to the cast selector of a distribution controller.

14. The arrangement according to claim 11, wherein the processing means is located in a cast selector of a distribution controller, wherein content information is retrieved from the streaming server via the policy node and the geographical information is retrieved from the policy node.

15. The arrangement according to claim 14, wherein the cast selector comprises means for requesting content information and geographical information from the policy node.

16. The arrangement according claim 14, wherein the selecting means is the cast selector.

17. The arrangement according to claim 11, wherein the retrieving means for retrieving geographical information comprises means for retrieving geographical information from the gateway via the Gx interface to the policy node.

18. The arrangement according to claim 17, wherein the geographical information is an identity of at least one cell.

19. The arrangement according to claim 17, wherein the geographical information is the Cell Global Identity or the Service Area Identity.

20. The arrangement according to claim 11, wherein the retrieving means for retrieving geographical information comprises means for retrieving geographical information from the Mobile Positioning Center, MPC to the policy node.

21. The arrangement according to claim 20, wherein the geographical information is an identity of at least one cell or geographical coordinates.
